(19) United States
(12) Patent Application Publication
(10) Pub. No.: US 2021/0149885 A1
(43) Pub. Date: May 20, 2021

(54) BLOCKCHAIN-BASED CONTENT PROCESSING METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventor: Xin LI, Shenzhen (CN)

(21) Appl. No.: 17/160,234

(22) Filed: Jan. 27, 2021

Related U.S. Application Data
(63) Continuation of application No. PCT/CN2020/117527, filed on Sep. 24, 2020.

(30) Foreign Application Priority Data
Sep. 29, 2019 (CN) 201910932221.5

(51) Int. Cl. G06F 16/23; G06F 16/27; G06F 16/22

(52) U.S. Cl. CPC G06F 16/2379; G06F 16/22; G06F 16/27

(57) ABSTRACT

A blockchain-based content processing method is provided. The method includes: obtaining, by a content server, fingerprint information of content data being published; transmitting, by the content server, the fingerprint information of the content data to a blockchain system; and storing, by the content server by using the fingerprint information of the content data as an index, the content data into a target file system in response to receiving a storage success message returned by the blockchain system.

### CROSS-REFERENCES TO RELATED APPLICATIONS

This application is a continuation application of PCT Patent Application No. PCT/CN2020/117527, filed on Sep. 24, 2020, which claims priority to Chinese Patent Application No. 201910932221.5, entitled “BLOCKCHAIN-BASED CONTENT PROCESSING METHOD AND APPARATUS, DEVICE, AND STORAGE MEDIUM” filed on Sep. 29, 2019, the entire contents of both of which are incorporated herein by reference.

### FIELD OF THE TECHNOLOGY

Embodiments of the present disclosure relate to the field of blockchain technologies, and in particular, to a content processing method and apparatus, a device, and a storage medium.

### BACKGROUND OF THE DISCLOSURE

With the development of network technologies and user content, a large amount of content data is usually generated on a network platform. Therefore, the processing of the content data is increasingly in focus. Generally, for content data, a relatively complex data storage system is adopted for storage of the content data, and consequently, a series of problems, such as a complex read procedure and a long read time, are generated, resulting in low efficiency of a content data processing procedure. Therefore, a content processing method of higher efficiency is urgently needed.

### SUMMARY

The embodiments of the present disclosure provides a blockchain-based content processing method and apparatus, a device, and a storage medium, to provide a content processing manner of higher efficiency. The technical solutions are as follows:

According to an aspect, a blockchain-based content processing method is provided, including: obtaining, by a content server, fingerprint information of content data being published; transmitting, by the content server, the fingerprint information of the content data to a blockchain system; and storing, by the content server by using the fingerprint information of the content data as an index, the content data into a target file system in response to receiving a storage success message returned by the blockchain system.

According to an aspect, a blockchain-based content processing method, applicable to a node device in a blockchain system, is provided, including: receiving, by the node device, fingerprint information of content data (e.g., transmitted by a content server), and broadcasting in the blockchain system; transmitting, by the node device, a verification success message in response to that no fingerprint information whose similarity with the fingerprint information of the content data is greater than or equal to a target threshold exists in fingerprint information stored in a blockchain of the blockchain system; and storing, by the node device, a block including the fingerprint information of the content data in the blockchain of the blockchain system in response to reaching, by the blockchain system, a consensus on the fingerprint information of the content data.

According to one aspect, a computer device is provided, including a processor and a memory, the memory storing at least one segment of program code, the at least one segment of program code being loaded and executed by the processor, to implement the blockchain-based content processing method according to any one of the foregoing. For example, the processor executed the at least one segment of program code to perform: obtaining fingerprint information of content data being published; transmitting the fingerprint information of the content data to a blockchain system; and storing, by using the fingerprint information of the content data as an index, the content data into a target file system in response to receiving a storage success message returned by the blockchain system.

According to one aspect, a non-transitory computer-readable storage medium is provided, storing at least one segment of program code, the at least one segment of program code being loaded and executed by a processor, to implement the blockchain-based content processing method according to any one of the foregoing. For example, the at least one segment of program code caused the processor to perform: obtaining fingerprint information of content data being published; transmitting the fingerprint information of the content data to a blockchain system; and storing, by using the fingerprint information of the content data as an index, the content data into a target file system in response to receiving a storage success message returned by the blockchain system.

The technical solutions provided in the embodiments of the present disclosure may bring the following beneficial effects:

Content data and fingerprint information thereof are stored in combination by providing a blockchain system and a target file system, and the fingerprint information may be persistently stored by using the blockchain system. In addition, by using the fingerprint information as a connection between the blockchain system and the target file system, and by taking advantage of characteristics of real and reliable data storage in the blockchain system, a storage manner with low data storage pressure may be provided, so that the data storage pressure is significantly reduced, and data processing efficiency can be improved.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from the accompanying drawings without creative efforts.

FIG. 1 is a schematic diagram of a plurality of blocks of a blockchain according to an embodiment of the present disclosure.

FIG. 2 is a schematic diagram of an implementation environment of a blockchain-based content processing method according to an embodiment of the present disclosure.

FIG. 3 is a flowchart of a blockchain-based content processing method according to an embodiment of the present disclosure.

FIG. 4 is a schematic diagram of a blockchain-based content processing apparatus according to an embodiment of the present disclosure.

FIG. 5 is a schematic diagram of a blockchain-based content processing apparatus according to an embodiment of the present disclosure.

FIG. 6 is a schematic structural diagram of a computer device according to an embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

First, several terms included in the present disclosure are explained.

Blockchain system refers to a system that stores data by using a block chain technology. Blockchain technology, also referred to as a distributed ledger technology, is an Internet database technology and features decentralization, openness, and transparency, thereby enabling all people to participate in database recording. The blockchain technology may be a distributed infrastructure and computing paradigm in which data is verified and stored by using a blockchain data structure, data is generated and updated by using a distributed node consensus algorithm, safety of data transmission and access is ensured by using cryptology, programming and operation on data are performed by using a smart contract including automation script code. The data stored in the blockchain system have high stability and reliability, and the blockchain system is a database that cannot be tampered with and that is reliable. Therefore, compared with a conventional manner in which storage is performed by using a content distribution server or a content server, storing data related to content data by using a blockchain system not only can ensure safety and reliability of the data, but also can provide data query and data comparison functions based on reliable storage.

The blockchain system includes a plurality of node devices. Data can be shared between node devices. Each node device can receive input information during normal operation, and maintain shared data in the blockchain system based on the received input information. To ensure an information exchange in the blockchain system, information connections exist among all the node devices in the blockchain system, and information transmission may be performed among the node devices through the foregoing information connections. For example, when any node device in the blockchain system receives input information, another node device in the blockchain system obtains the input information according to a consensus algorithm, and stores the input information as data in shared data, so that consistent data is stored in all node devices in the blockchain system.

TABLE 1

| Node device name | Node device identifier |
|---|---|
| Node device 1 | 117.114.151.174 |
| Node device 2 | 117.116.189.145 |
| . . . | . . . |
| Node device N | 119.123.789.258 |

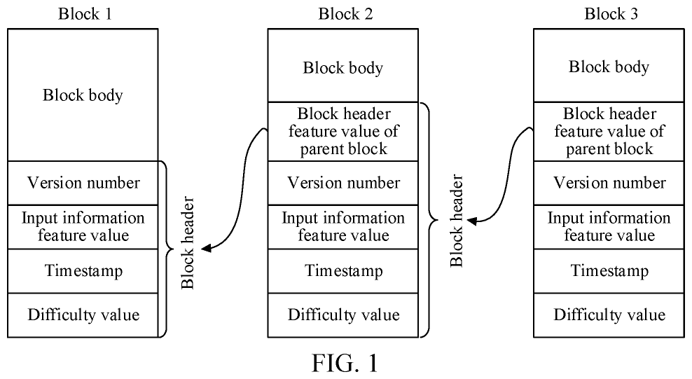

For each node device in the blockchain system, there is a node device identifier corresponding to the node device. Each node device in the blockchain system stores node device identifiers of other node devices in the blockchain system, to help subsequently broadcast a generated block to other node devices in the blockchain system according to the node device identifiers of other node devices. Each node device may maintain a node device identifier list as shown in FIG. 1, and a node device name and a node device identifier are correspondingly stored in the node device identifier list. Optionally, a node device identifier is an Internet Protocol (IP) address or any other information that can be used for identifying the node device. In Table 1, description is made by using only an IP address as an example.

All node devices in the blockchain system are equipped with a same blockchain. The blockchain includes a plurality of blocks. Referring to FIG. 1, a founding block includes a block header and a block body. The block header stores an input information feature value, a version number, a timestamp, and a difficulty value. The block body stores input information. A next block of the founding block uses the founding block as a parent block, and also includes a block header and a block body. The block header stores an input information feature value of a current block, a block header feature value of the parent block, a version number, a timestamp, and a difficulty value. By analogy, block data stored in each block in the blockchain is associated with block data stored in the parent block, thereby ensuring the security of the input information in the blocks.

Block height refers to a quantity of blocks linked to a main chain, that is, a quantity of blocks connected to a blockchain.

Consensus algorithm refers to a mathematical algorithm for building trust and obtaining rights and interests between different node devices in a blockchain system. In a blockchain system, a transaction can be verified and confirmed in a short time through voting of special node devices. For a transaction, if several node devices that are irrelevant to each other in terms of interests can reach a consensus, it can be considered that all node devices in the system can also reach a consensus.

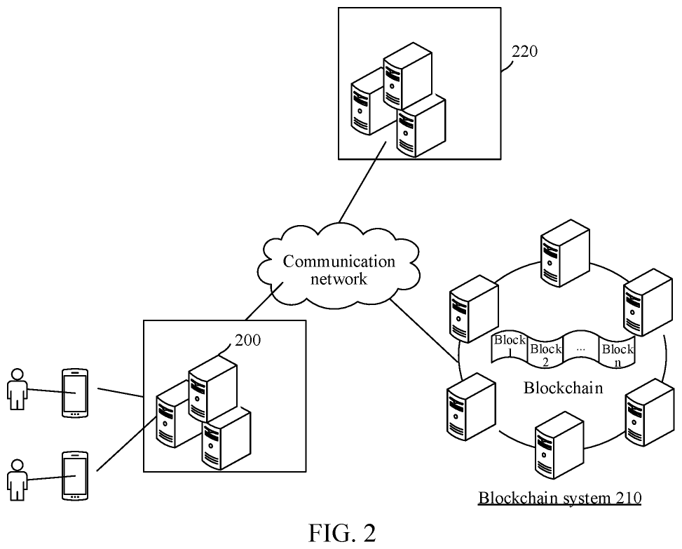

FIG. 2 is a schematic diagram of an implementation environment of a blockchain-based content processing method according to an embodiment of the present disclosure. The implementation environment includes at least one content server 200, a blockchain system 210, and a target file system 220.

The content server 200 is a server of any content platform. A user publishes content data on the content platform, for example, publishes a short video or a webpage article. Here, the content data published by the user may be referred as newly published content data or content data being published. When obtaining newly published content data, the content server 200 stores the content data by using the blockchain system 210 and the target file system 220. Optionally, the content server 200 further has a function of providing a user customized service, for example, recommending content data for a user.

The blockchain system 210 includes a plurality of node devices. The plurality of node devices include a management node device used as a processing bridge between the blockchain system and the target file system. The target file system 220 includes a plurality of storage devices. Each storage device may be used for content storage to support writing content into and reading content from a target file system. The blockchain system 210 is used for storing fingerprint information of content data stored in the target file system 220. Compared with the content data, the fingerprint information has a smaller data volume. Therefore, node storage pressure of a blockchain system can be alleviated, so that each node device can store more information. For example, for the target file system 220, when content data is stored, a key-value pair is used for storage, key being fingerprint information and value being content data, so that fast storage is provided.

In a possible implementation, a node device the blockchain system 210 is provided as a server, for example, a server, a server cluster including a plurality of servers, or a cloud computing service center. Each storage device in the target file system 220 is a storage device in any storage format. This is not limited in the embodiments of the present disclosure.

A communication connection can be established between the content server 200, the blockchain system 210, and the target file system 220 by using a wired or wireless network. The wired network is a metropolitan area network, a local area network, a fiber optic network, or the like; and the wireless network may be a mobile communication network or a wireless fidelity (Wi-Fi) network.

A person skilled in the art is to understand that, the foregoing content server 200, the blockchain system 210, and the target file system 220 are merely examples. Other existing systems or systems possibly appearing in future, if applicable to the present disclosure, are also to fall within the protection scope of the present disclosure and are included herein by reference.

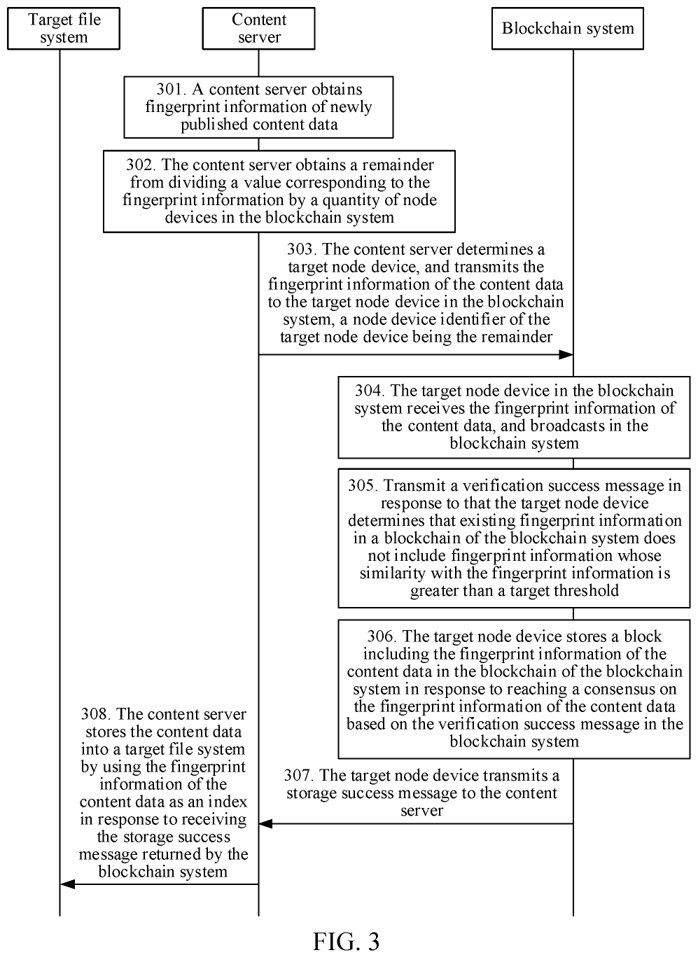

Based on the implementation environment shown in FIG. 2, one embodiment of the present disclosure provides a blockchain-based content processing method by using an example in which the method is applicable to interaction processes among a content server, a blockchain system, and a target file system. As shown in FIG. 3, the method provided in one embodiment of the present disclosure includes the following steps:

301. A content server obtains fingerprint information of newly published content data.

The content data is any web-published content, for example, text data or multimedia data. For example, the newly published content data refers to one or more pieces of content data of which a publishing time is nearest to the current time. In another example, the newly published content data refers to one or more pieces of content data of which a publishing time falls within a most recent time period. This is not limited in the embodiments of the present disclosure.

The content server can obtain content data published by a user in a login state or as a visitor. The content server stores the content data, and can further perform publishing based on the stored content data, to ensure normal and quick spreading of the content data. After storage, the content server may generate fingerprint information of the content data based on a target feature value algorithm and the content data.

In a possible implementation, step 301 may include: obtaining, according to a publishing source of the content data, a target feature value algorithm matching the publishing source; and generating fingerprint information of the content data based on the target feature value algorithm and the content data. The publishing source refers to a publishing platform, a publishing sector on a platform, or the like of the content data. Different publishing platforms or publishing sectors may have different characteristics in terms of content and form. Therefore, for the different characteristics, corresponding feature value algorithms are set, to ensure that the generated fingerprint information can be distinguished more clearly.

In a possible implementation, the content server generates fingerprint information of any content data by using a same feature value algorithm. In another possible implementation, the content server generates, by using different feature value algorithms, fingerprint information of pieces of content data having different sources. This is not limited in the embodiments of the present disclosure. For example, the feature value algorithm is a hash algorithm.

302. The content server obtains a remainder from dividing a value corresponding to the fingerprint information by a quantity of node devices in the blockchain system. In some embodiments, the value corresponding to the fingerprint information may be the hash value obtained from the feature value algorithm.

The content server and the blockchain system cooperate with each other. Therefore, the content server can learn about a quantity of current node devices in the blockchain system. To disperse storage pressure, the content server can determine, according to the fingerprint information and the quantity of node devices in the blockchain system, a node device to which the fingerprint information of the content data is transmitted. For example, a processing manner of step 302 is adopted to determine a target node device in the form of taking a remainder.

303. The content server determines a target node device, and transmits the fingerprint information of the content data to the target node device in the blockchain system, a node device identifier of the target node device being the remainder.

For a blockchain system, there is a unique node device identifier corresponding to each node device. For example, when the node device identifier is a numerical number, after determining a remainder from dividing a value corresponding to fingerprint information by a quantity of node devices, the content server transmits the fingerprint information by using the remainder as a selected node device identifier.

For example, the fingerprint information is a series of 64-bit harsh integers calculated and generated based on the Message-Digest Algorithm 5 (MD5) encryption algorithm. A remainder is obtained through calculation of a formula (1) below:

id=hash(content) % N (1)

where id is a remainder obtained by calculation, that is, a node device identifier of a target node device, hash ( ) represents a hash function, content represents content data, % represents an operation of obtaining the remainder, N represents a quantity of node devices in a blockchain system, and N is a positive integer greater than 3.

In one embodiment of the present disclosure, only an example in which a content server determines a target node device is used as an example for description. However, in some possible implementations, the content server directly transmits fingerprint information to a blockchain system. After the fingerprint information is received, a management node or a gateway node device of the blockchain system determines the foregoing target node device based on the fingerprint information, and further, the management node device or the gateway node device transmits the fingerprint information to the target node device. A specific implementation of the foregoing procedure is not limited in the embodiments of the present disclosure.

304. The target node device in the blockchain system receives the fingerprint information of the content data, and broadcasts in the blockchain system.

For any node device in the blockchain system, when receiving the fingerprint information of the content data, the node device can spread the fingerprint information to each node device in the blockchain system by broadcasting in the blockchain system.

305. Transmit a verification success message in response to that the target node device determines that existing fingerprint information in a blockchain of the blockchain system does not include fingerprint information whose similarity with the fingerprint information is greater than a target threshold.

Any node device in the blockchain system can query existing fingerprint information in the blockchain after receiving the fingerprint information. The existing fingerprint information is fingerprint information stored in the blockchain, and is fingerprint information of published content data on the content server. A similarity is calculated based on the existing fingerprint information and the received fingerprint information. When a similarity between the received fingerprint information and any piece of existing fingerprint information is not greater than the target threshold, it is determined that the fingerprint information is successfully verified, and a verification success message is broadcast in the blockchain system.

In the foregoing process, because fingerprint information is used for uniquely identifying a piece of content data, a similarity between fingerprint information can reflect whether pieces of content data are the same or similar, to determine whether same or similar content data has been published. For pieces of content data that are the same or similar, it is very likely that there are cases such as plagiarism, that is, current intellectual property plagiarism such as manuscript washing. Therefore, through the query and comparison, it is determined whether a behavior, such as the foregoing plagiarism, has occurred, to ensure interests of originators.

306. The target node device stores a block including the fingerprint information of the content data in the blockchain of the blockchain system in response to reaching a consensus on the fingerprint information of the content data based on the verification success message in the blockchain system.

The reaching a consensus refers to that a target quantity of node devices in the blockchain system determine, through verification, that the node devices do not store the fingerprint information. For the blockchain system, consensus is performed on the foregoing fingerprint information based on any consensus mechanism. For example, consensus is performed by using a representative node device. That is, a representative node device in the blockchain system performs verification and transmits a verification success message. When an enough quantity of representative node devices transmit the verification success message, it is determined that a consensus on the fingerprint information is reached. In another example, it is adopted that all node devices participate in consensus. That is, when receiving the fingerprint information, each node device in the blockchain system performs verification and transmits a verification success message. When an enough quantity of node devices transmit the verification success message, it is determined that a consensus on the fingerprint information is reached.

The foregoing block including the fingerprint information of the content data may be generated by any node device and broadcast in the blockchain system, or may be generated by the foregoing representative node device and broadcast in the blockchain system, so that each node device can receive the block and stores the block, thereby ensuring consistency of data in the blockchain system.

Optionally, the block including the fingerprint information of the content data further includes link address information and a content change history of the content data. The link address information is used for uniquely identifying the fingerprint information of the content data in the blockchain system. When a user terminal accesses the content data through the link address information, the content server transmits an access request to the blockchain system based on the link address information. The blockchain system finds through query, based on the link address information, the fingerprint information stored in the block, and queries a target file system by using the fingerprint information as an index, to obtain corresponding content data stored in the target file system. The content change history is used for representing a publishing time, an update, and the like of the content data, and is not limited in the embodiments of the present disclosure.

Through the foregoing consensus mechanism of the blockchain system, publication of content data and any modification to the content data can both be recorded on the blockchain, so that the content data can be effectively prevented from being illegally tampered with in a spreading process. Even if the content data is tampered with, the tampering can be followed, and a time of the tampering and a person making the tampering may be tracked by using data on the data on the blockchain, thereby maintaining the content data.

Further, when consensus in the blockchain system fails, a storage failure message is transmitted to the content server. The storage failure message is used for representing that the content data may be plagiarized content.

Optionally, the block including the fingerprint information of the content data may further include user feedback information. For the user feedback information, when any node device in the blockchain system receives user feedback information of any user for second content data, second fingerprint information of the second content data and the user feedback information for the second content data are correspondingly stored in the blockchain. By storing the user feedback information in the blockchain, the user feedback information is recorded in a block and spread to the entire blockchain system.

The user feedback information refers to feedback information collected based on the published content data and is of any feedback type such as an evaluation feedback, a scoring feedback, or a reporting feedback. The evaluation feedback is comment information, reply information, or the like. The scoring feedback is specific scoring information, and the reporting feedback is complaint information, reporting information, or the like against the published content data. In a possible implementation, the content server provides, through an access page of the content data, a page for accessing a questionnaire, or the like, a feedback menu and a feedback entry for users to submit feedback information to the content server, for example, “Like”, “Report”, or “Dislike”. The feedback mechanism based on user voting can be used as an effective supplement to the consensus mechanism, and provide an important data reference for protecting content data, promoting positive feedback, and the like. The feedback mechanism may be particularly useful in discovering “secret plagiarism” which produces plagiarized content through various “washing” methods designed to go around the similarity comparison mechanism.

Based on the foregoing user feedback information, a blockchain-based user incentive mechanism is provided, to encourage users to participate in performing feedback for content data, so that more accurate and credible feedback can be based on, and users can further be motivated to provide content data of higher quality. Specifically, the user feedback information-based processing includes at least one of (1) to (3) described below.

(1) Accumulate, based on the user feedback information, a participation score for a first target user providing the user feedback information, and reward the first target user based on the accumulated participation score.

A corresponding reward is given for participation of a user, to motivate the user to participate. A user identifier of the first target user submitting user feedback information is extracted from the user feedback information, and a participation score is accumulated for the first target user. For example, each time the first target user submits user feedback information, a target participation score is accumulated for the first target user. When the participation score of the first target user reaches a reward score, the first target user is rewarded.

(2) When it is determined that third content data fails to conform to a target rule, accumulate contribution points, based on user feedback information for the third content data, accumulate contribution points for second target user providing positive user feedback information, and reward the second target user based on the accumulated contribution score.

A corresponding reward is given for effective feedback of a user, to enhance motivate the user to participate and increase effective feedback. A user identifier of the second target user providing user feedback information is extracted from the user feedback information, and a contribution score is accumulated for the second target user. For example, each time the second target user submits user feedback information, a target contribution score is accumulated for the second target user. When the contribution score of the second target user reaches a reward score, the second target user is rewarded.

Effective user feedback information refers to that the user feedback information has positive effect on identifying illegal content or providing a reference for another user. Therefore, a contribution score is set for quantifying such positive effect. For example, if any content data is determined as illegal information, user feedback information corresponding to the content data is obtained, and a user submitting illegality reporting information in the user feedback information is determined and rewarded. Certainly, for content data determined as legal information, user feedback information corresponding to the content data is obtained, and a user submitting illegality reporting information in the user feedback information is determined and punished. For example, an account of the user is closed.

Certainly, the foregoing two incentive manners for participation and rewarding can alternatively be combined into an overall incentive manner. For example, an incentive function is defined as G(U)=f (accumulated participation score, accumulated positive contribution score), where G(U) represents a right allocation index score of a user U. A standard for setting a value of the foregoing incentive function includes: A higher accumulated participation score indicates a larger value of G(U); and a higher accumulated contribution score indicates a larger value of G(U). Through such a combined incentive manner, when a user is encouraged to participate, the user is also encouraged to provide more accurate feedback, thereby avoiding cases such as a false charge. Certainly, the foregoing two factors, namely, the participation score and the contribution score, are both positively correlated to G(U). A final value of G(U) is obtained in a weighted summation manner.

The foregoing reward is a virtual reward or an actual reward given for a user and is flexibly specified according to a platform, and for example, is a point coupon reward or a VIP user qualification reward. In addition, for a blockchain system, the foregoing scores of each user can be periodically counted, to achieve a regular incentive.

(3) Accumulate, according to received user feedback information, a content quality score for third target user submitting the content data, and when a content quality score of the content data is lower than a target quality score, process at least one of the content data and the third target user.

Both of (1) and (2) are about incentive measures for users submitting user feedback information. However, for the third target user submitting content data, quality evaluation is performed, based on feedback information, on the content published by the third target user. For any piece of content data, user feedback information for the content data in a blockchain system is obtained. According to a feedback type corresponding to the user feedback information, a score accumulation standard corresponding to the feedback type is obtained, so that a content quality score can be accumulated based on the user feedback information and the score accumulation standard. For example, when the feedback type is evaluation feedback, a quantity of pieces of evaluation information is counted. A score accumulation standard is a correspondence between the quantity and a score, and a current accumulated content quality score is determined based on the quantity. When the user feedback information is positive feedback, for example, Like or Thumb-up, the accumulated content quality score is a positive number. When the user feedback information is negative feedback, for example, Dislike or Thumb-down, the accumulated content quality score is a negative number, or the accumulated content quality score is a score to be reduced this time. Certainly, another calculation manner can alternatively be used. That is, for any user feedback information, accumulation is performed, to obtain a content quality score of a positive number. Content quality is measured by using a specific score as a cutoff score. When the feedback type is reporting feedback, a quantity of times of reporting is counted. The score accumulation standard is a correspondence between the quantity of times of reporting and a score, and a current accumulated content quality score is determined based on the quantity of times of reporting. When the feedback type is evaluation feedback, a quantity of pieces of evaluation information is counted. A score accumulation standard may be a correspondence between the quantity and a score, and a current to-be-reduced content quality score is determined based on the quantity. When the feedback type is interaction feedback, for example, user feedback information is Like, Forward, or the like, a quantity of times of interaction is counted. The score accumulation standard is a correspondence between the quantity of times of interaction and a score, and a current accumulated content quality score is determined based on the quantity of times of interaction.

In a possible implementation, to ensure quantity of content data presented on a platform, content data can further be processed based on the foregoing content quality score. For example, when the content quality score is lower than a target quality score, the content data is deleted from a target file system. The procedure specifically includes: obtaining periodically a content quality score corresponding to fingerprint information of each piece of content data in a blockchain system; transmitting a delete request to a target file system when a content quality score of any piece of content data is lower than a target quality score, the delete request carrying fingerprint information of the content data; and deleting, by the target file system after receiving the delete request, the content data.

307. The target node device transmits a storage success message to the content server.

After the block is added to the blockchain, the target node device transmits a storage success message to the content server, to inform the content server of successful storage.

308. The content server stores the content data into a target file system by using the fingerprint information of the content data as an index in response to receiving the storage success message returned by the blockchain system.

After determining that the storage succeeds, the content server stores the content data to the target file system. However, for the target file system, a relatively fast and convenient storage system is provided by using a Key-Value mechanism included in the foregoing embodiment. In this case, the fingerprint information of the content data is used as Key, and the content data is used as Value, thereby implementing the storage of the content data and providing a basis for subsequent quick query.

In a possible implementation, when receiving a storage failure message returned by the blockchain system, the content server can learn about that the content data is similar content, and process at least one of the content data and the publishing user of the content data (e.g., by flagging the content data and/or the publishing user for further validation or for punishing operation. For plagiarized content, content data is deleted or processed in another manner, and for a publishing user of the plagiarized content, punishment, such as closing an account, is performed. Certainly, to avoid false processing, target fingerprint information can further be obtained from the blockchain system based on fingerprint information whose similarity is greater than a target threshold, the target fingerprint information being fingerprint information whose similarity with the fingerprint information is greater than the target threshold. Content data corresponding to the target fingerprint information is obtained from the target file system by using the target fingerprint information as an index, and is submitted to an administrator for a manual review. If it is determined, through the manual review, that the content data is plagiarized content, the content data is punished, and if it is determined, through the manual review, that the content data is not plagiarized content, the content data is not processed, and is marked and transmitted to the blockchain system again.

In a possible implementation, the foregoing content quality score may further play a significant role in recommendation, that is, the method further include: determining, by using a content quality score of candidate content data as a sorting factor and at least one piece of correlation information, content data satisfying recommendation requirements in the candidate content data when content data recommendation is performed, the content quality score being determined based on the user feedback information.

When data content recommendation is performed, any one or a combination of the following recommendation methods is used, for example, 1) user interest tag mining; 2) content tag mining; 3) a user-interest-and-content matching algorithm; and 4) user-interest collaborative filtering. The foregoing recommendation methods are implemented in a manner such as mining user interests, mining content tags that a user has browsed or watched, interest-content matching, or prediction based on similar users' interests. That is, recommendation is performed by using correlation information of a user. Because a content quality score of the content data can be determined based on the foregoing user feedback information, the content quality score is used as a sorting factor. When a candidate recommendation list is determined during a push procedure, with reference to other correlation information (tag correlation, keyword correlation, category correlation, and the like), a recommendation score of the candidate content data and a recommendation score of each user are respectively calculated, and content data recommendation is performed for a user according to a specified recommendation rule in descending order of scores.

According to technical solutions provided by the embodiments of the present disclosure, content data and fingerprint information thereof are stored in combination by providing a blockchain system and a target file system, and the fingerprint information can be persistently stored by using the blockchain system. By using the fingerprint information as a connection between the blockchain system and the target file system, and by taking advantage of characteristics of real and reliable data storage in the blockchain system, a storage manner with low data storage pressure is provided, so that the data storage pressure is significantly reduced, and data processing efficiency can be improved.

Further, by providing the blockchain system and the target file system to store the content data and the fingerprint information thereof in combination, the fingerprint information of the content data can uniquely and independently determine a similarity between content data, so that a content server can publish content based on the similarity of content data, and determine plagiarized data, thereby greatly reducing data storage pressure while protecting the content data. In addition, due to a characteristic that data can be rapidly spread by using the blockchain system, the problem of large communication latency can be resolved. By storing only fingerprint information in the blockchain system, and storing the content data by using the target file system, the problem of a small storage space can also be avoided. Further, the embodiments of the present disclosure belong to the field of machine learning and artificial intelligence technologies, and in particular, relate to content distribution in a blockchain environment. In addition, a feedback mechanism is also established, to resolve quality problems and copyright dispute problems of content services. Further, a corresponding recommendation mechanism is also provided, to solve the problem of effective matching between user interests and content. This technical solution provides an effective method for suppressing plagiarism and spreading.

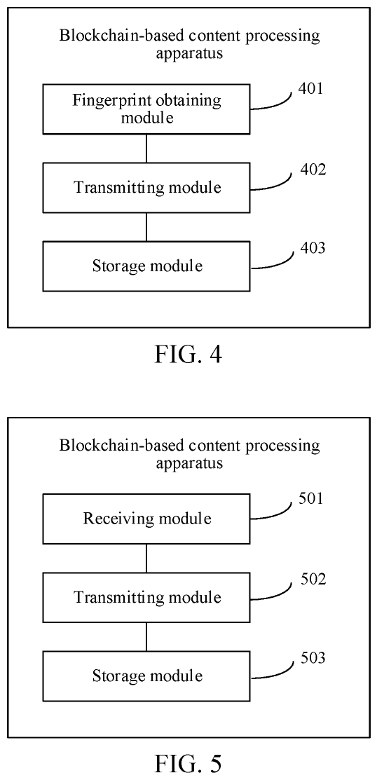

Based on the same technical conception, referring to FIG. 4, an embodiment of the present disclosure provides a content processing apparatus, including:

a fingerprint obtaining module 401, configured to obtain fingerprint information of newly published content data;

a transmitting module 402, configured to transmit the fingerprint information of the content data to a blockchain system; and

a storage module 403, configured to store the content data in a target file system by using the fingerprint information of the content data as an index in response to receiving a storage success message returned by the blockchain system.

In a possible implementation, the fingerprint obtaining module 401 is configured to:

obtain, according to a publishing source of the content data, a target feature value algorithm matching the publishing source; and

generate the fingerprint information of the content data based on the target feature value algorithm and the content data.

In a possible implementation, the transmitting module 402 is configured to:

obtain a remainder between the fingerprint information and a quantity of node devices in the blockchain system (e.g., obtaining a remainder from dividing a value corresponding to the fingerprint information by a quantity of node devices in the blockchain system); and

determine a target node device, and transmit the fingerprint information of the content data to the target node device in the blockchain system. A node device identifier of the target node device is the remainder.

In a possible implementation, the storage success message is transmitted when the blockchain system does not store content data whose similarity is greater than a target threshold, and a consensus is reached.

The apparatus further includes: a plagiarism processing module, configured to process at least one of the content data and a publishing user of the content data in response to receiving a storage failure message returned by the blockchain system.

In a possible implementation, the apparatus further includes:

a content data obtaining module, configured to obtain target fingerprint information from the blockchain system, the target fingerprint information being fingerprint information whose similarity with the fingerprint information is greater than the target threshold; and obtain content data corresponding to the target fingerprint information from the target file system by using the target fingerprint information as an index.

In a possible implementation, the apparatus further includes: a recommendation module, configured to determine, by using a content quality score of candidate content data as a sorting factor and at least one piece of correlation information, content data satisfying recommendation requirements in the candidate content data when content data recommendation is performed, the content quality score being determined based on the user feedback information.

When the apparatus provided in the foregoing embodiments implements functions of the apparatus, it is illustrated with an example of division of each functional module. In the practical application, the function distribution may be finished by different functional modules according to the requirements, that is, the internal structure of the device is divided into different functional modules, to implement all or some of the functions described above. In addition, the apparatus and method embodiments provided in the foregoing embodiments belong to one conception. For the specific implementation process, reference may be made to the method embodiments, and details are not described herein again.

Based on the same technical conception, referring to FIG. 5, an embodiment of the present disclosure provides a content processing apparatus, including:

a receiving module 501, configured to receive fingerprint information of content data transmitted by a content server;

a transmitting module 502, configured to broadcast in a blockchain system,

the transmitting module 502 being further configured to transmit a verification success message in response to successfully verifying the fingerprint information; and

a storage module 503, configured to store a block including the fingerprint information of the content data in the blockchain of the blockchain system in response to reaching, by the blockchain system, a consensus on the fingerprint information of the content data,

the transmitting module 502 being further configured to transmit a storage success message to the content server.

In a possible implementation, fingerprint information verification refers to determining whether fingerprint information stored in blocks of the blockchain system includes fingerprint information whose similarity with the fingerprint information is greater than a target threshold. If yes, the verification fails; and if not, the verification succeeds.

In a possible implementation, the successfully verifying refers to that no fingerprint information whose similarity with the fingerprint information of the content data is greater than or equal to the target threshold exists in existing fingerprint information in a node device.

In a possible implementation, the reaching a consensus refers to that a target quantity of node devices in the blockchain system successfully verify the fingerprint information.

In a possible implementation, the transmitting module is further configured to transmit the storage success message to the content server in response to a verification success.

In a possible implementation, the transmitting module is further configured to transmit the storage failure message to the content server in response to a verification failure.

In a possible implementation, the apparatus further includes:

a determining module, configured to determine, according to first link address information carried in a read instruction, a first block corresponding to the first link address information on the blockchain in response to receiving the read instruction; and

an extraction module, configured to extract first fingerprint information corresponding to the first link address information from the first block;

the transmitting module 502 being further configured to return the first fingerprint information, the first fingerprint information being used for reading first content data corresponding to the first fingerprint information from a target file system.

In a possible implementation, the block further includes link address information and a content change history of the content data.

In a possible implementation, the block further includes user feedback information.

In a possible implementation, the storage module is further configured to store correspondingly, in response to receiving user feedback information of any user for second content data, second fingerprint information of the second content data and the user feedback information for the second content data in the blockchain.

In a possible implementation, the apparatus further includes a user processing module, configured to perform at least one of the following:

accumulating, based on the user feedback information, a participation score for a first target user providing the user feedback information, and rewarding the first target user based on the accumulated participation score;

accumulating, based on user feedback information for third content data in response to that it is determined that the third content data does not conform to a target rule, a contribution score for second target user providing positive user feedback information, and rewarding the second target user based on the accumulated contribution score; and

accumulating, according to received user feedback information, a content quality score for the second target user submitting the content data, and processing at least one of the content data and the second target user in response to that the content quality score of the content data is lower than a target quality score.

When the apparatus provided in the foregoing embodiments implements functions of the apparatus, it is illustrated with an example of division of each functional module. In the practical application, the function distribution may be finished by different functional modules according to the requirements, that is, the internal structure of the device is divided into different functional modules, to implement all or some of the functions described above. In addition, the apparatus and method embodiments provided in the foregoing embodiments belong to one conception. For the specific implementation process, reference may be made to the method embodiments, and details are not described herein again.

Each module/unit and/or submodule/subunit in various disclosed embodiments can be integrated in a processing unit, or each module/unit and/or submodule/subunit can exist separately and physically, or two or more modules/units and/or submodule/subunit can be integrated in one unit. The modules/units and/or submodule/subunit as disclosed herein can be implemented in the form of hardware (e.g., processing circuitry and/or memory) or in the form of software functional unit(s) (e.g., developed using one or more computer programming languages), or a combination of hardware and software.

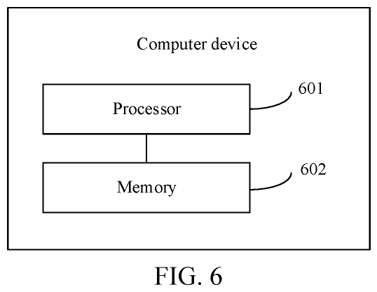

FIG. 6 is a schematic structural diagram of a computer device according to an embodiment of the present disclosure. The computer device may refer to any node device or content server in the foregoing embodiments. The computer device may vary a lot due to different configurations or performance, and may include one or more central processing units (CPUs) 601 and one or more memories 602. The one or more memories 602 store at least one segment of program code, the at least one segment of program code being loaded and executed by the one or more CPUs 601, to implement the blockchain-based content processing method provided in the foregoing method embodiments. Certainly, the computer device may also have components such as a wired or wireless network interface, a keyboard, and an input/output interface for ease of input/output, and may further include other components for implementing functions of the device. Details are not provided herein.

In a possible implementation, the foregoing computer device provides a server, the server including a processor and a memory, the memory storing at least one segment of program code, the program code being loaded and executed by the processor, to implement the following method:

obtaining fingerprint information of newly published content data;

transmitting the fingerprint information of the content data to a blockchain system; and

storing the content data in a target file system by using the fingerprint information of the content data as an index in response to receiving a storage success message returned by the blockchain system.

In a possible implementation, the processor is further configured to perform the following steps: obtaining a target feature value algorithm according to a publishing source of the content data, the target feature value algorithm matching the publishing source; and generating the fingerprint information of the content data based on the target feature value algorithm and the content data.

In a possible implementation, the processor is further configured to perform the following steps: obtaining a remainder between the fingerprint information and a quantity of node devices in the blockchain system;

determining a target node device, the target node device being a node device of which a node device identifier is the remainder; and

transmitting the fingerprint information of the content data to the target node device in the blockchain system.

In a possible implementation, the storage success message is transmitted by the blockchain system after a consensus is reached.

The processor is further configured to perform the following step: processing at least one of the content data and a publishing user of the content data when a storage failure message returned by the blockchain system is received.

In a possible implementation, the processor is further configured to perform the following steps: obtaining target fingerprint information from the blockchain system, the target fingerprint information being fingerprint information whose similarity with the fingerprint information is greater than a target threshold; and

obtaining content data corresponding to the target fingerprint information from the target file system by using the target fingerprint information as an index.

In a possible implementation, the processor is further configured to perform the following step: transmitting user feedback information for any content data to the blockchain system.

In a possible implementation, the processor is further configured to perform the following step:

determining, by using a content quality score of candidate content data as a sorting factor and at least one piece of correlation information, content data satisfying recommendation requirements in the candidate content data when content data recommendation is performed, the content quality score being determined based on the user feedback information stored in the blockchain system.

In a possible implementation, the foregoing computer device provides a server, the server including a processor and a memory, the memory storing at least one segment of program code, the program code being loaded and executed by the processor, to implement the following method.

In a possible implementation, the foregoing computer device provides a server, the server being a node device in the blockchain system and including a processor and a memory, the memory storing at least one segment of program code, the program code being loaded and executed by the processor, to implement the following method:

receiving fingerprint information of content data, and broadcasting in the blockchain system;

transmitting a verification success message in response to successfully verifying the fingerprint information; and

storing a block including the fingerprint information of the content data in the blockchain of the blockchain system in response to reaching, by the blockchain system, a consensus on the fingerprint information of the content data.

In a possible implementation, the successfully verifying refers to that no fingerprint information whose similarity with the fingerprint information of the content data is greater than or equal to a target threshold exists in existing fingerprint information in the server.

In a possible implementation, the reaching a consensus refers to that a target quantity of node devices in the blockchain system successfully verify the fingerprint information.

In a possible implementation, the block further includes link address information and a content change history of the content data.

In a possible implementation, the processor is further configured to perform the following steps:

determining, according to first link address information carried in a read instruction, a first block corresponding to the first link address information on the blockchain in response to receiving the read instruction; and

extracting first fingerprint information corresponding to the first link address information from the first block, and returning the first fingerprint information, the first fingerprint information being used for reading first content data corresponding to the first fingerprint information from the target file system.

In a possible implementation, the processor is further configured to perform the following step:

storing correspondingly, in response to receiving user feedback information of any user for second content data, second fingerprint information of the second content data and the user feedback information for the second content data in the blockchain.

In an exemplary embodiment, a computer-readable storage medium is further provided, the storage medium storing at least one segment of program code, the at least one segment of program code being loaded and executed by a processor of a computer device, to implement any foregoing blockchain-based content processing method.

Optionally, the foregoing computer-readable storage medium may be a read-only memory (ROM), a random-access memory (RAM), a compact disc ROM (CD-ROM), a magnetic tape, a floppy disk, an optical data storage device, or the like.

In an exemplary embodiment, a computer program product is further provided, storing at least one segment of program code, the at least one segment of program code being loaded and executed by a processor of a computer device, to implement any foregoing blockchain-based content processing method.

“Plurality of” mentioned in the specification means two or more. “And/or” describes an association relationship for describing associated objects and represents that three relationships may exist. For example, A and/or B may represent the following three cases: Only A exists, both A and B exist, and only B exists. The character “/” in this specification generally indicates an “or” relationship between the associated objects.

The foregoing descriptions are merely examples of the embodiments of the present disclosure, but are not intended to limit the present disclosure. Any modification, equivalent replacement, or improvement made without departing from the spirit and principle of the present disclosure shall fall within the protection scope of the present disclosure.

What is claimed is:

1. A blockchain-based content processing method, comprising:
obtaining, by a content server, fingerprint information of content data being published;
transmitting, by the content server, the fingerprint information of the content data to a blockchain system; and
storing, by the content server by using the fingerprint information of the content data as an index, the content data into a target file system in response to receiving a storage success message returned by the blockchain system.

2. The method according to claim 1, wherein the obtaining, by a content server, fingerprint information of content data being published comprises:
obtaining, by the content server according to a publishing source of the content data, a target feature value algorithm matching the publishing source; and
generating, by the content server, the fingerprint information of the content data based on the target feature value algorithm and the content data.

3. The method according to claim 1, wherein the transmitting, by the content server, the fingerprint information of the content data to a blockchain system comprises:
obtaining, by the content server, a remainder from dividing a value corresponding to the fingerprint information by a quantity of node devices in the blockchain system;
determining, by the content server, a target node device, a node device identifier of the target node device being the remainder; and
transmitting, by the content server, the fingerprint information of the content data to the target node device in the blockchain system.

4. The method according to claim 1, wherein the storage success message is transmitted by the blockchain system after a consensus is reached; and
after the transmitting, by the content server, the fingerprint information of the content data to a blockchain system, the method further comprises:
processing, by the content server, at least one of the content data and a publishing user of the content data in response to receiving a storage failure message returned by the blockchain system.

5. The method according to claim 4, further comprising:
obtaining, by the content server, target fingerprint information from the blockchain system, the target fingerprint information being fingerprint information whose similarity with the fingerprint information of the content data is greater than a target threshold; and
obtaining, by the content server, target content data corresponding to the target fingerprint information from the target file system by using the target fingerprint information as an index, wherein the target content data and the content data corresponding to the storage failure message are submitted for review.

6. The method according to claim 1, further comprising:
transmitting, by the content server, user feedback information of any piece of candidate content data to the blockchain system.

7. The method according to claim 6, further comprising:
determining, by the content server by using a content quality score of the candidate content data as a sorting factor and at least one piece of correlation information, content data satisfying recommendation requirements in the candidate content data when performing content data recommendation, the content quality score being determined based on the user feedback information stored in the blockchain system.

8. The method according to claim 1, further comprising:
receiving, by a node device in the block chain system, the fingerprint information of the content data transmitted by the content server, and broadcasting in the blockchain system;
transmitting, by the node device, a verification success message in response to successfully verifying the fingerprint information; and
storing, by the node device, a block comprising the fingerprint information of the content data in a blockchain of the blockchain system in response to reaching, by the blockchain system, a consensus on the fingerprint information of the content data.

9. The method according to claim 8, wherein the successfully verifying the fingerprint information includes that no fingerprint information whose similarity with the fingerprint information of the content data is greater than or equal to a target threshold exists in existing fingerprint information of the node device.

10. The method according to claim 8, wherein the reaching a consensus includes that a target quantity of node devices in the blockchain system successfully verify the fingerprint information.

11. The method according to claim 8, wherein the block further comprises link address information and a content change history of the content data.

12. The method according to claim 8, further comprising:
determining, by the node device according to first link address information carried in a read instruction, a first block corresponding to the first link address information on the blockchain in response to receiving the read instruction; and
extracting, by the node device, first fingerprint information corresponding to the first link address information from the first block, and returning the first fingerprint information, the first fingerprint information being used for reading first content data corresponding to the first fingerprint information from the target file system.

13. The method according to claim 6, further comprising:
storing correspondingly, by a node device in response to receiving the user feedback information of any user for the candidate content data, second fingerprint information of the candidate content data and the user feedback information for the candidate content data in the blockchain.

14. A computer device, comprising a processor and a memory, the memory storing at least one segment of program code, the at least one segment of program code being loaded and executed by the processor, to implement:
obtaining fingerprint information of content data being published;
transmitting the fingerprint information of the content data to a blockchain system; and
storing, by using the fingerprint information of the content data as an index, the content data into a target file system in response to receiving a storage success message returned by the blockchain system.

15. The device according to claim 14, wherein the obtaining fingerprint information of content data being published comprises:
obtaining, according to a publishing source of the content data, a target feature value algorithm matching the publishing source; and
generating the fingerprint information of the content data based on the target feature value algorithm and the content data.

16. The device according to claim 14, wherein the transmitting the fingerprint information of the content data to a blockchain system comprises:
obtaining a remainder from dividing a value corresponding to the fingerprint information by a quantity of node devices in the blockchain system;
determining a target node device whose node device identifier is the remainder; and
transmitting the fingerprint information of the content data to the target node device in the blockchain system.

17. The device according to claim 14, wherein the storage success message is transmitted by the blockchain system after a consensus is reached; and
after the transmitting the fingerprint information of the content data to a blockchain system, the processor is further configured to implement:
processing at least one of the content data and a publishing user of the content data in response to receiving a storage failure message returned by the blockchain system.

18. The device according to claim 17, wherein the processor is further configured to implement:
obtaining target fingerprint information from the blockchain system, the target fingerprint information being fingerprint information whose similarity with the fingerprint information of the content data is greater than a target threshold; and
obtaining target content data corresponding to the target fingerprint information from the target file system by using the target fingerprint information as an index, wherein the target content data and the content data corresponding to the storage failure message are submitted for review.

19. The device according to claim 14, wherein the processor is further configured to implement:
transmitting user feedback information of any piece of candidate content data to the blockchain system; and
determining, by using a content quality score of the candidate content data as a sorting factor and at least one piece of correlation information, content data satisfying recommendation requirements in the candidate content data when performing content data recommendation, the content quality score being determined based on the user feedback information stored in the blockchain system.

20. A non-transitory computer-readable storage medium, storing at least one segment of program code, the at least one segment of program code being loaded and executed by a processor, causing the processor to implement:
obtaining fingerprint information of content data being published;
transmitting the fingerprint information of the content data to a blockchain system; and
storing, by using the fingerprint information of the content data as an index, the content data into a target file system in response to receiving a storage success message returned by the blockchain system.
